(19) United States
(12) Patent Application Publication
(10) Pub. No.: US 2022/0061226 A1
(43) Pub. Date: Mar. 3, 2022

(54) PLANTS ILLUMINATION SYSTEM

(71) Applicant: BEN KLEMO BERDA, YEHUD (IL)

(72) Inventor: BEN KLEMO BERDA, YEHUD (IL)

(21) Appl. No.: 17/131,815

(22) Filed: Dec. 23, 2020

Related U.S. Application Data
(60) Provisional application No. 63/073,458, filed on Sep. 2, 2020.

(51) Int. Cl. A01G 7/04; F21V 14/02; A01G 9/26; H05B 47/115

(52) U.S. Cl. CPC A01G 7/045; H05B 47/115; A01G 9/26; F21V 14/02

(57) ABSTRACT

A plants illumination system, including at least one sensor for determining differences of growth levels between different plants, a elongated illumination source for illuminating the plants for providing photosynthesis illumination therefor, at least one motor for moving the elongated illumination source in relation to the plants, and a controller for controlling the at least one motor to control the moving of the elongated illumination source in relation to the plants according to the at least one sensor for differentiating the photosynthesis illumination between the plants as a function of differences of the growth level thereof for equalizing the growth levels.

### CROSS-REFERENCE TO RELATED APPLICATIONS

This application claims the benefit of priority from U.S. Provisional Patent Application No. 63/073,458, filed Sep. 2, 2020, the disclosure of which is incorporated herein by reference.

### TECHNICAL FIELD

The invention relates to the field of plant growing systems. More particularly, the invention relates to a method and apparatus for illuminating the plant.

### BACKGROUND

FIG. 1 is a front view of a prior art domestic plant compartment and plats being grown.

The problem is that the sun 12 illuminates stronger on plants disposed near the window, and weaker on plants disposed far from the window.

Accordingly, plants receiving weaker illumination grow slower, whereas there is a long felt need to obtain equal growing for all plants.

### SUMMARY

A plants illumination system, including:
a sensor for determining differences of growth levels;
an elongated illumination source; and
a motor, for moving the elongated illumination source.

thereby equalizing growth levels.

### BRIEF DESCRIPTION OF THE DRAWINGS

Embodiments, features, and aspects of the invention are described herein in conjunction with the following drawings:

FIG. 1 is a front view of a prior art domestic plant compartment and plats being grown.

FIG. 2 is a top view of a plant growing system according to one embodiment at the first step.

FIG. 3 is a front view of the plant growing system of FIG. 2.

FIG. 4 is the front view of the plant growing system of FIG. 2 after a period of using the system.

FIG. 5 depicts an even illuminating program.

FIG. 6 is the front view of the plant growing system of FIG. 2 after a period of using the system.

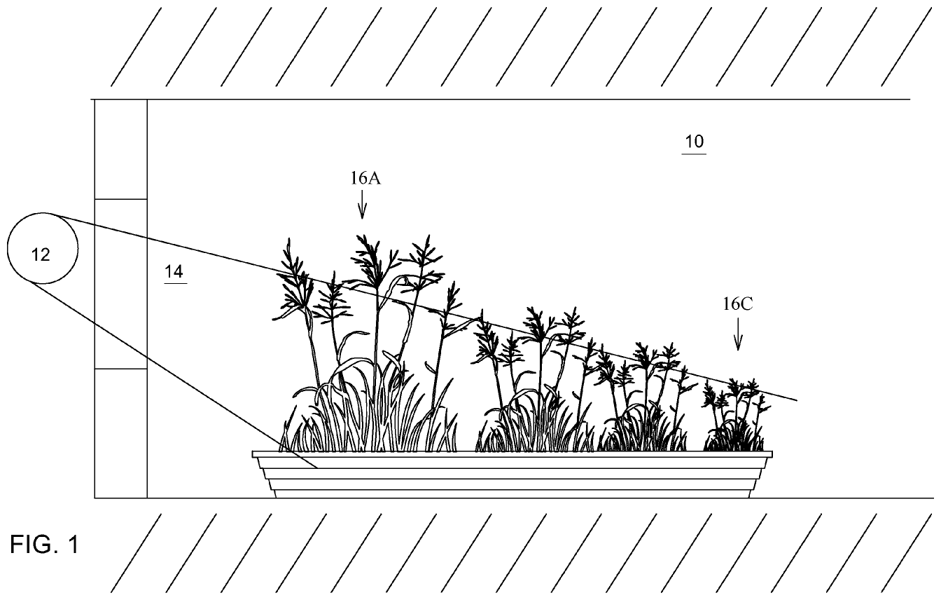

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

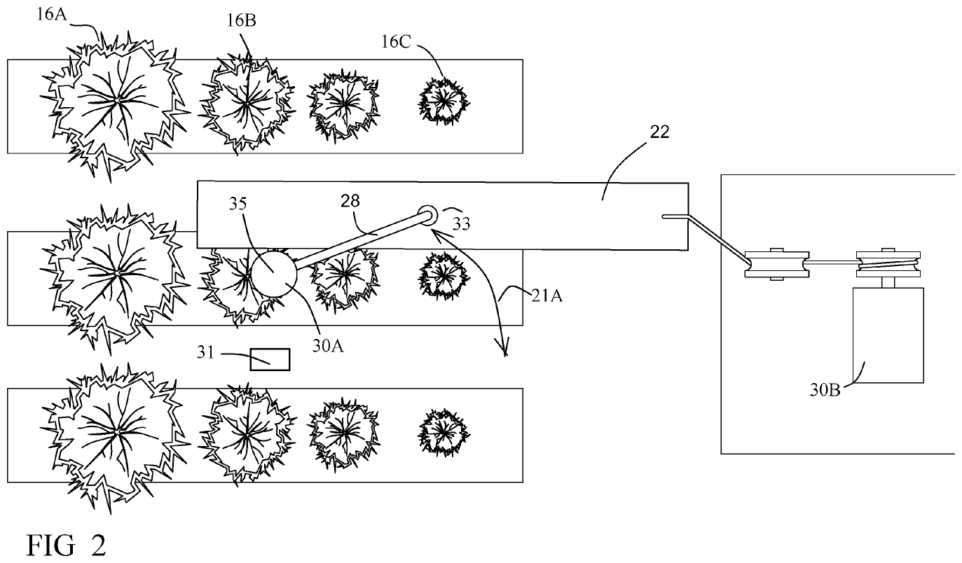

FIG. 2 is a top view of a plant growing system according to one embodiment at the first step.

A plants illumination system 10 includes an elongated illumination source 22, for illuminating the plants; an arm 28 for horizontally moving (21A) elongated illumination source 22; a motor 30A for moving arm 28; and a controller 31 for controlling motor 30A.

Elongated illumination source 22 is assumed to equally illuminate therealong.

According to one embodiment, motor 30A rotates arm 28 and elongated illumination source 22 around motor 30A.

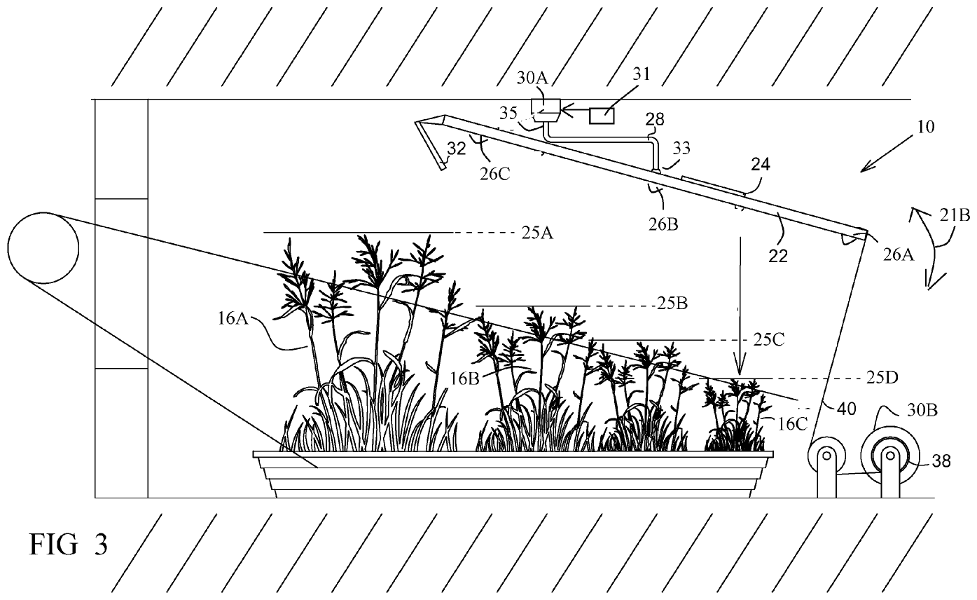

FIG. 3 is a front view of the plant growing system of FIG. 2

The term “equal illumination” refers herein to spectral illumination being effective to photosynthesis, according to spectral power distribution (SPI)) and its influence on the plants, since for example green illumination less contributes to photo synthesis.

Controller 31 runs motor 30A as a function of sensors 26A, 26B, 26C disposed along elongated illumination source 22, measuring the distances of each to locations 27A, 27B and 27C of compartment 29, for providing even/equal illumination to 27A, 27B and 27C.

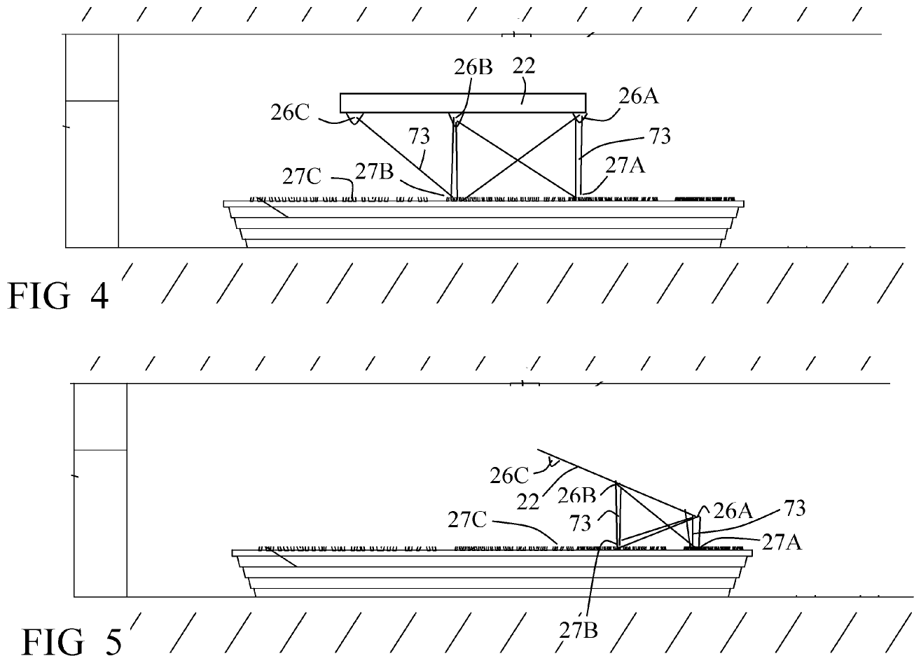

FIG. 4 depicts an example of non-even illumination.

For example, continuous horizontal disposition of elongated illumination source 22 is an incorrect illuminating program, since location 27B, being the center receives overall larger cumulative illumination, illustrated by 4 rays 73, in relation to side location 27A, illustrated by receiving 3 rays 73 only.

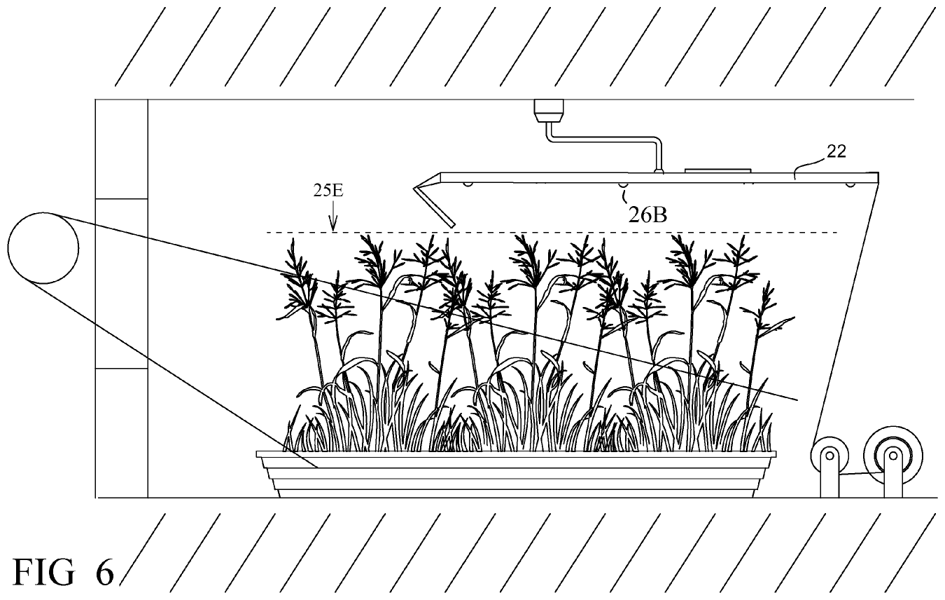

FIG. 5 depicts an even illuminating program.

Rather, elongated illumination source 22 is tilted by the controller towards side location 27A as shown in FIG. 4, for increasing the illumination there, as shown by rays 73 shown stronger in the figure, and at other periods is be tilted towards side location 27C (not shown), for obtaining equal cumulative illumination locations 27A, 27B and 27C.

Referring again to FIG. 3, being upon growing of plants, controller 31 runs motor 30A as a function of sensors 26A, 26B, 26C measuring then height and area of the plants, for moving arm 28 in changeable speeds, for increasing the illumination period for the weaker plants in relation to the strong plants.

Elongated illumination source 22 further includes a hinge 33, for tilting (21B) elongated illumination source 22 by a motor 30B, such as a step motor, via a wire 40.

Controller 31 controls motor 30B as a function of sensors 26A, 26B, etc. measuring the height and area of the plants, for decreasing the distance of the illumination, thus increasing the intensity for the weaker plants in relation to the strong plants.

FIG. 6 is the front view of the plant growing system of FIG. 2 after a period of using the system.

After a period of controlled increasing the illumination for the weaker plants, the plants have an equal growth level 25E, as controller as provided equal illumination to the plants.

Thus, in one aspect, the invention is directed to a plants illumination system (10), including:
an elongated illumination source (22), for illuminating plants (16A,16B,16C), for providing photosynthesis illumination therefor;
sensors (26A, 26B), for determining distances between each of a plurality of locations along the elongated illumination source (22) and each of a plurality of locations (27A,27B) of the plants;
at least one motor (30A,30B), for moving the elongated illumination source (22) in relation to the plants (16A,16B,16C); and
a controller (31), for controlling the at least one motor (30A,30B), to control the moving of the elongated illumination source (22) in relation to the plants (16A,16B,16C) according to the sensors (26A,26B), for obtaining equal cumulative illuminations to the locations (27A,27B) of the plants;

The controller (31) may further be configured for controlling the at least one motor (30A,30B), to control the moving of the elongated illumination source (22) in relation to the plants (16A,16B,16C) according to the sensors (26A,26B), for differentiating the photosynthesis illumination between the plants (16A,16B,16C) as a function of differences of the growth level thereof, for equalizing the growth levels.

The plants illumination system (10) may further include an illumination source (12) being non-controllable, thereby the elongated illumination source (22) is configured to compensate over non uniform illumination of the non-controllable illumination source (12).

The controlling of the moving of the elongated illumination source (22) in relation to the plants (16A,16B,16C) for differentiating the photosynthesis illumination between the plants (16A,16B,16C) may apply differentiating horizontal motion for differentiating illumination periods.

The controlling of the moving of the elongated illumination source (22) in relation to the plants (16A,16B,16C) for differentiating the photosynthesis illumination between the plants (16A,16B,16C) may apply differentiating the distance of the elongated illumination source (22) for differentiating illumination intensity.

The plants illumination system (10) may further include an arm (28), for horizontally rotating (21A) the elongated illumination source (22) by the at least one motor (30A,30B).

The horizontal rotating of the illumination source (22) may apply elliptic motion.

The plants illumination system (10) may further include a hinge (31), for tilting (21B) the elongated illumination source (22) by the at least one motor (30A,30B).

In the figures and/or description herein, the following reference numerals (Reference Signs List) have been mentioned:
numeral 10 denotes the plants illumination system according to one embodiment of the invention;
12: non-controllable illumination source, such as the sun;
14: building window;
16A,16B,16C: different plants;
21A: horizontal motion;
21B: tilting;
22: elongated illumination source, such as a lamp;
25A,25B,25C,25D,25E: heights of plants, indicating growth levels;
28: arm;
26A: sensor disposed at a first location along elongated illumination source 22 for sensing distances from sensor 26A and locations 27A, 27B of the plants;
26B: sensor disposed at a second location along elongated illumination source 22 for sensing distances from sensor 26B and locations 27A, 27B of the plants;
27A,27B,27B: locations along the plants compartment and/or along the plants;
30A,30B: motors;
31: controller;
32: solar panel for energizing motors 30A,30B;
33: hinge;
35: axle of motor 30A;
38: pulley for collecting wire 40;
40: wire;
73: illumination ray.

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A plants illumination system, comprising:
an elongated illumination source, for illuminating plants, for providing photosynthesis illumination therefor;
sensors, for determining distances between each of a plurality of locations along the elongated illumination source and each of a plurality of locations of the plants;
at least one motor, for moving the elongated illumination source in relation to the plants; and
a controller, for controlling the at least one motor, to control the moving of the elongated illumination source in relation to the plants according to the sensors, for obtaining equal cumulative illuminations to the locations of the plants;

2. The plants illumination system according to claim 1, wherein the controller is further configured for controlling the at least one motor, to control the moving of the elongated illumination source in relation to the plants according to the at sensors, for differentiating the photosynthesis illumination between the plants as a function of differences of the growth level thereof, for equalizing the growth levels.

3. The plants illumination system according to claim 1, further comprising at least an illumination source being non-controllable, thereby the elongated illumination source is configured to compensate over non uniform illumination of the non-controllable illumination source.

4. The plants illumination system according to claim 1, wherein the controlling the moving of the elongated illumination source comprises differentiating horizontal motion for differentiating illumination periods.

5. The plants illumination system according to claim 1, wherein the controlling the moving of the elongated illumination source in relation to the plants comprises differentiating a distance of the elongated illumination source for differentiating illumination intensity.

6. The plants illumination system according to claim 1, further comprising an arm, for horizontally rotating the elongated illumination source by the at least one motor.

7. The plants illumination system according to claim 6, wherein the horizontal rotating of the elongated illumination source comprises elliptic motion.

8. The plants illumination system according to claim 1, further comprising a hinge, for tilting the elongated illumination source by the at least one motor.
